(19) United States
(12) Patent Application Publication
(10) Pub. No.: US 2025/0061655 A1
(43) Pub. Date: Feb. 20, 2025

(54) VIRTUAL SCENE-BASED INTERACTION METHOD

(71) Applicant: Tencent Technology (Shenzhen) Company Limited, Shenzhen (CN)

(72) Inventor: Teng CHEN, Shenzhen (CN)

(73) Assignee: Tencent Technology (Shenzhen) Company Limited, Shenzhen (CN)

(21) Appl. No.: 18/934,928

(22) Filed: Nov. 1, 2024

Related U.S. Application Data
(63) Continuation of application No. PCT/CN2023/124101, filed on Oct. 11, 2023.

(30) Foreign Application Priority Data
Dec. 15, 2022 (CN) 202211626109.7

(51) Int. Cl. G06T 17/00; G06F 3/16; G06T 13/40

(52) U.S. Cl. CPC G06T 17/00; G06F 3/165; G06T 13/40

(57) ABSTRACT

An interaction method based on a virtual scene is provided. In the method, a first virtual object in a to-be-synchronized state and a state synchronization area are displayed in a first virtual scene. The first virtual object is controlled by a first user associated with a first account. A second virtual object is displayed outside of the state synchronization area in the virtual scene. The second virtual object is controlled by a second user associated with a second account. When the second virtual object enters the state synchronization area, state representation information indicating that the second virtual object is in the to-be-synchronized state is output.

### RELATED APPLICATIONS

The present application is a continuation of International Application No. PCT/CN2023/124101, filed on Oct. 11, 2023, which claims priority to Chinese Patent Application No. 202211626109.7, filed on Dec. 15, 2022. The entire disclosures of the prior applications are hereby incorporated by reference.

### FIELD OF THE TECHNOLOGY

This disclosure relates to data processing technologies in the field of computer applications, including to an interaction method based on a virtual scene, an electronic device, a computer storage medium, and a computer program product.

### BACKGROUND OF THE DISCLOSURE

A man-machine interaction technology for a virtual scene based on graphics processing hardware can implement, according to an actual application requirement, diversified interaction between virtual objects controlled by a user or artificial intelligence, and has broad practical value. For example, in a virtual scene of a game, a real interaction process between virtual characters can be simulated.

In an interaction scene, to implement interaction between two accounts, usually one account invites the other account, and the two accounts perform interaction when the other account accepts the invitation. In this way, the interaction between the two accounts requires a complete invitation acceptance procedure, affecting interaction efficiency.

### SUMMARY

Aspects of this disclosure provide an interaction method based on a virtual scene, an electronic device, a computer storage medium, and a computer program product, to improve interaction efficiency.

Technical solutions in the aspects of this disclosure are implemented as follows.

An aspect of this disclosure provides an interaction method based on a virtual scene. The interaction method is performed by an electronic device, for example. In the method, a first virtual object in a to-be-synchronized state and a state synchronization area are displayed in a first virtual scene. The first virtual object is controlled by a first user associated with a first account. A second virtual object is displayed outside of the state synchronization area in the virtual scene. The second virtual object is controlled by a second user associated with a second account. When the second virtual object enters the state synchronization area, state representation information indicating that the second virtual object is in the to-be-synchronized state is output.

An aspect of this disclosure further provides an information processing apparatus. The information processing apparatus includes processing circuitry that is configured to display a first virtual object in a to-be-synchronized state and a state synchronization area in a virtual scene. The first virtual object is controlled by a first user associated with a first account. The processing circuitry is configured to display a second virtual object outside of the state synchronization area in the virtual scene. The second virtual object is controlled by a second user associated with a second account. When the second virtual object enters the state synchronization area, the processing circuitry is configured to output state representation information indicating that the second virtual object is in the to-be-synchronized state.

An aspect of this disclosure further provides an interaction method based on a virtual scene, performed by an electronic device, the method including: in response to a state setting operation on a first virtual object, displaying, in a second virtual scene, the first virtual object in a to-be-synchronized state and a state synchronization area corresponding to the to-be-synchronized state, the first virtual object corresponding to a first account; and displaying, based on an interaction operation between the first virtual object and a second virtual object, an interaction picture showing that the second virtual object and the state synchronization area approach each other, the second virtual object corresponding to a second account, the interaction operation representing interaction between the first account and the second account, and when the interaction picture shows that the second virtual object enters the state synchronization area, the second electronic device being configured to output state representation information indicating that the second virtual object is in the to-be-synchronized state, and the second electronic device being an electronic device logged in by the second account.

An aspect of this disclosure provides a first electronic device for interaction based on a virtual scene, including: a first memory, configured to store computer-executable instructions; and a first processor, configured to implement the interaction method based on a virtual scene, performed by an electronic device when executing the computer-executable instructions stored in the first memory, the method comprising in response to a state setting operation on a first virtual object, displaying, in a second virtual scene, the first virtual object in a to-be-synchronized state and a state synchronization area corresponding to the to-be-synchronized state, the first virtual object corresponding to a first account; and displaying, based on an interaction operation between the first virtual object and a second virtual object, an interaction picture showing that the second virtual object and the state synchronization area approach each other, the second virtual object corresponding to a second account, the interaction operation representing interaction between the first account and the second account, and when the interaction picture shows that the second virtual object enters the state synchronization area, the second electronic device being configured to output state representation information indicating that the second virtual object is in the to-be-synchronized state, and the second electronic device being an electronic device logged in by the second account.

An aspect of this disclosure provides a non-transitory computer-readable storage medium storing instructions which when executed by at least one processor cause the at least one processor to perform any one or a combination of the interaction methods.

Aspects of this disclosure can at least have the following beneficial effects. The first virtual object is associated with the first account, the second virtual object is associated with the second account, and the state synchronization area is displayed when the first virtual object is in the to-be-synchronized state, so that the interaction between the first account and the second account is triggered, when the first account and the second account are simultaneously in the to-be-synchronized state, by the second virtual object entering the state synchronization area. In this way, entering the state synchronization area can trigger the interaction between the virtual objects that are simultaneously in the same to-be-synchronized state. Compared with the solution in the related art that requires the virtual objects participating in the interaction to request the interaction from another virtual object and wait for the another virtual object to accept the interaction, the solution provided in the aspects of this disclosure does not require the virtual objects to transmit requests to each other, and only needs to control the second virtual object to enter the state synchronization area. In this way, the interaction between the two virtual objects can be implemented, and interaction complexity can be reduced. Because an additional interaction request does not need to be transmitted, and there is no need to wait for or receive confirmation from and/or another virtual object regarding accepting the interaction request, the solution provided in the aspects of this disclosure can reduce computing resources required for the interaction between the virtual objects and improve interaction efficiency.

### BRIEF DESCRIPTION OF THE DRAWINGS

FIG. 1 is an example schematic diagram of interaction.

FIG. 2 is a schematic diagram of an architecture of an interaction system based on a virtual scene according to an aspect of this disclosure.

FIG. 3 is a schematic diagram of a structure of a terminal in FIG. 2 according to an aspect of this disclosure.

FIG. 4 is a schematic diagram of another structure of a terminal in FIG. 2 according to an aspect of this disclosure.

FIG. 5 is a schematic flowchart 1 of an interaction method in a virtual scene according to an aspect of this disclosure.

FIG. 6 is a schematic diagram 1 of an example interaction interface according to an aspect of this disclosure.

FIG. 7 is a schematic flowchart 2 of an interaction method in a virtual scene according to an aspect of this disclosure.

FIG. 8 is a schematic diagram 2 of an example interaction interface according to an aspect of this disclosure.

FIG. 9 is an example interaction diagram of a second virtual object entering a state synchronization area according to an aspect of this disclosure.

FIG. 10 is a schematic flowchart 3 of an interaction method in a virtual scene according to an aspect of this disclosure.

FIG. 11 is an example schematic flowchart of listening to music together according to an aspect of this disclosure.

FIG. 12 is a schematic diagram of state setting according to an aspect of this disclosure.

FIG. 13 is a schematic diagram of an example trigger state change according to an aspect of this disclosure.

FIG. 14 is an example schematic diagram of displaying prompt information according to an aspect of this disclosure.

FIG. 15 is an example schematic diagram of synchronously listening to music according to an aspect of this disclosure.

FIG. 16 is an example schematic diagram of exiting from a music listening state according to an aspect of this disclosure.

FIG. 17 is another example schematic diagram of exiting from a music listening state according to an aspect of this disclosure.

FIG. 18 is an example schematic diagram of interaction of listening to music together according to an aspect of this disclosure.

### DESCRIPTION OF ASPECTS

To make the objectives, technical solutions, and advantages of this disclosure clearer, the following describes this disclosure in further detail with reference to the accompanying drawings. The described aspects are not to be considered as a limitation to this disclosure. Other aspects obtained by a person of ordinary skill in the art shall fall within the protection scope of this disclosure.

In the following descriptions, related “some aspects” describe a subset of all possible aspects. However, the “some aspects” may be the same subset or different subsets of all the possible aspects, and may be combined with each other without conflict.

In the following descriptions, the included term “first/second” is merely intended to distinguish similar objects but does not necessarily indicate a specific order of an object. “First/second” is interchangeable in examples of terms of a specific order or sequence if permitted, so that the aspects of this disclosure described herein can be implemented in a sequence in addition to the sequence shown or described herein. The descriptions of the terms are provided as examples only and are not intended to limit the scope of the disclosure.

Unless otherwise defined, meanings of all technical and scientific terms used in this aspect are the same as those usually understood by a person skilled in the art to which this application belongs. Terms used in this aspect of this application are merely intended to describe objectives of the aspects of this disclosure, but are not intended to limit this application.

Before the aspects of this application are further described in detail, a description is made on nouns and terms involved in the aspects of this application, and the nouns and terms involved in the aspects of this disclosure are applicable to the following explanations.

(1) Artificial intelligence (AI) may refer to a theory, method, technology, and disclosure system that uses a digital computer or a machine controlled by the digital computer to simulate, extend, and expand human intelligence, perceive an environment, obtain knowledge, and use knowledge to obtain an optimal result. In the aspects of this disclosure, state content of a second virtual object can be determined by the artificial intelligence.

(2) A virtual scene may refer to a virtual scene displayed (or provided) when an application is run on a terminal device, or may be a virtual scene played by receiving audio and video information transmitted by a cloud server, where the application is run on the cloud server. In addition, the virtual scene may be a simulated environment of a real world, or may be a semi-simulated and semi-fictional virtual environment, or may be a completely fictional virtual environment. The virtual scene may be any one of a two-dimensional virtual scene, a 2.5-dimensional virtual scene, or a three-dimensional virtual scene, and a dimension of the virtual scene is not limited in the aspects of this disclosure. For example, the virtual scene may include the virtual sky, the virtual land, the virtual ocean, or the like. The virtual land may include environmental elements such as the virtual desert and a virtual city. The user may control the virtual object to move in the virtual scene.

(3) Virtual objects may refer to pictures of various people and objects that can interact in the virtual scene, or movable objects in the virtual scene. The movable object may be a virtual character, a virtual animal, a virtual vehicle, a cartoon character, or the like, for example, a character, an animal, or the like displayed in the virtual scene. The virtual object may be a virtual picture used for representing a user in the virtual scene. The virtual scene may include a plurality of virtual objects, and each virtual object has a shape and a volume in the virtual scene, and occupies some space in the virtual scene, for example, a first virtual object and the second virtual object in the aspects of this disclosure.

(4) A cloud technology may refer to a collective name of a network technology, an information technology, an integration technology, a platform management technology, an application technology, and the like based on an application of a cloud computing business mode, and may form a resource pool, which is used as required, and is flexible and convenient.

(5) A control/control device may refer to triggerable information displayed in a form of an area, a button, an icon, a link, text, a selection box, an input box, a tab, and the like. A trigger manner may be a contact trigger, a contactless trigger, an instruction-receiving trigger, or the like. In addition, various controls in the aspects of this disclosure may be a single control or a collective name of a plurality of controls.

(6) An operation may refer to a manner used to trigger a device to perform processing, such as a tapping operation, a double-tapping operation, a touch-and-hold operation, a swiping operation, a gesture operation, and a received trigger instruction. In addition, various operations in the aspects of this disclosure may be a single operation or a collective name of a plurality of operations; and various operations in the aspects of this disclosure may be touch operations or non-touch operations.

(7) “In response to” may be used for representing a condition or status on which one or more operations to be performed depend. When the condition or status is met, the one or more operations may be performed immediately or after a set delay. Unless otherwise specified, there is no restriction on an order in which the operations are performed.

(8) State, appearance and behavior, or a condition of a material system. In the academic field, “state” may refer to a process in which an object is involved, which is represented by a set of physical quantities. In the aspects of this disclosure, the state is used to represent a condition of the virtual object or a behavior performed by the virtual object.

(9) State synchronization may refer to processing that enables at least two virtual objects to be in a same state. A to-be-synchronized state includes a state synchronization function, and the state synchronization function refers to the following function: When one virtual object is in the to-be-synchronized state, another virtual object is assimilated, so that the another virtual object is also in the same state.

(10) A state synchronization area may refer to an area with the state synchronization function. When one virtual object is in the state synchronization area, another virtual object who belongs to the state synchronization area is in the same state. For example, a virtual object A is in a music listening state, and the virtual object A has the state synchronization area. After a virtual object B enters the state synchronization area of the virtual object A, the virtual object B is also in the music listening state.

In an interaction scene, to implement interaction between two accounts, usually one account invites the other account, and the two accounts perform interaction when the other account accepts the invitation. In this way, the interaction between the two accounts requires a complete invitation acceptance procedure, affecting interaction efficiency.

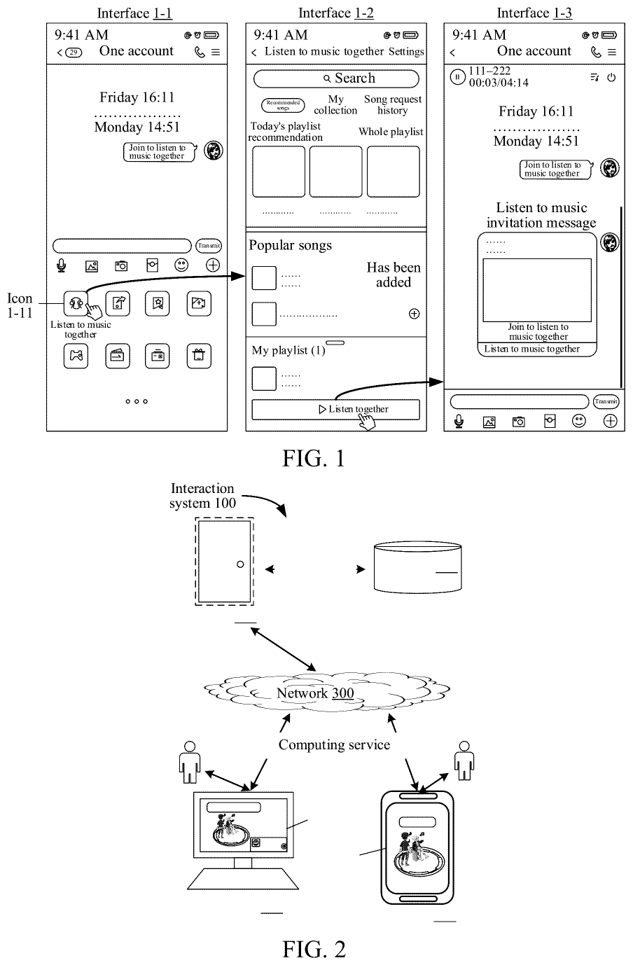

For example, FIG. 1 is an example schematic diagram of interaction. As shown in FIG. 1, when one account invites the other account to listen to music together, in a chat box shown in an interface 1-1 corresponding to one account, a displayed icon 1-11 (“listening to music together”) is triggered, and an interface 1-2 is displayed in response to a trigger operation on the icon 1-11. A song to be listened to together is obtained in response to a song selection operation in the interface 1-2, a music listening invitation is transmitted to the other account in response to a determining operation on a button (“listening together”) for the song, and an interface 1-3 is displayed. A music listening invitation message is displayed in the interface 1-3, so that the other account implements, in response to the music listening invitation, interaction of listening to music together between the two accounts.

However, in interaction manners such as implementing the interaction of listening to music together, the interaction between the two accounts requires a complete invitation acceptance procedure, affecting interaction efficiency. In addition, an interaction process is the interaction between the two accounts, which affects an interaction effect.

Based on this, the aspects of this disclosure provide an interaction method and apparatus based on a virtual scene, an electronic device, a computer-readable storage medium, and a computer program product, to improve the interaction efficiency and a visualization effect of the interaction. The following describes an example application of the electronic device provided in the aspects of this disclosure. The electronic device provided in the aspects of this disclosure can be implemented as various types of terminals such as a smartphone, a smart watch, a laptop computer, a tablet computer, a desktop computer, a smart home appliance, a set-top box, a smart vehicle-mounted device, a portable music player, a personal digital assistant, a dedicated messaging device, a smart voice interaction device, a portable gaming device, and a smart speaker, and can also be implemented as a server, or a combination of the two. Example applications are described below when the electronic device is implemented as a terminal.

FIG. 2 is a schematic diagram of an architecture of an interaction system based on a virtual scene according to an aspect of this disclosure. As shown in FIG. 2, to support an interaction application based on a virtual scene, in an interaction system 100, a terminal 400 (referred to as a first electronic device) and a terminal 200 (referred to as a second electronic device) are connected to a server 600 via a network 300. The server 600 is configured to provide computing services to the terminal 400 and the terminal 200, and the network 300 may be a wide area network or a local area network, or a combination of the two. In addition, the interaction system 100 further includes a database 500, configured to provide data support for the server 600; and FIG. 2 shows a case in which the database 500 is independent of the server 600. In addition, the database 500 may be further integrated in a server 200. This is not limited in the aspects of this disclosure.

The terminal 200 is configured to display, in a first virtual scene, a first virtual object in a to-be-synchronized state and a state synchronization area corresponding to the to-be-synchronized state, the first virtual object being associated with a first account; display, based on an interaction operation between the first virtual object and a second virtual object, an interaction picture showing that the second virtual object and the state synchronization area approach each other, the second virtual object being associated with a second account, and the interaction operation representing interaction between the first account and the second account; and when the interaction picture shows that the second virtual object enters the state synchronization area, output, in response to the second virtual object entering the state synchronization area, state representation information (where a graphics interface 200-1 is shown as an example) indicating that the second virtual object is in the to-be-synchronized state.

The terminal 400 is configured to: in response to a state setting operation on a first virtual object, display, in a second virtual scene, the first virtual object in a to-be-synchronized state and a state synchronization area corresponding to the to-be-synchronized state, the first virtual object corresponding to a first account; and display, based on an interaction operation between the first virtual object and a second virtual object, an interaction picture showing that the second virtual object and the state synchronization area approach each other, the second virtual object corresponding to a second account, the interaction operation representing interaction between the first account and the second account, and when the interaction picture shows that the second virtual object enters the state synchronization area, the second electronic device being configured to output state representation information indicating that the second virtual object is in the to-be-synchronized state, and the second electronic device being an electronic device (where a graphics interface 400-1 is shown as an example) logged in by the second account.

In some aspects, the server 600 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal 200 and the terminal 400 each may be a smartphone, a smart watch, a laptop computer, a tablet computer, a desktop computer, a smart television, a set-top box, a smart vehicle-mounted device, a portable music player, a personal digital assistant, a dedicated messaging device, a portable gaming device, a smart speaker, or the like, but are not limited thereto. The terminal and the server may be directly or indirectly connected in a wired or wireless communication manner. This is not limited in the aspects of this disclosure.

In some aspects, the server and the terminal device implement, in collaboration, the interaction method based on a virtual scene provided in the aspects of this disclosure. The solution implemented in collaboration by the terminal device and the server mainly relates to two game modes, namely, a local game mode and a cloud game mode respectively. The local game mode means that the terminal device and the server run, in collaboration, game logic processing. A part of operation instructions entered by a player in the terminal device are for the terminal device to run the game logic processing, and the other part of the operation instructions entered by the player in the terminal device are for the server to run the game logic processing. In addition, the game logic processing run by the server is often more complex, and requires more computing power. The cloud gaming mode means that the game logic processing is completely run by the server, and the cloud server renders game scene data into audio and video streams, and the audio and video streams are transmitted to the terminal device for display via the network. The terminal device only needs to have a basic streaming media playing capability and a capability to obtain the operation instructions of the player and transmit the operation instructions to the server.

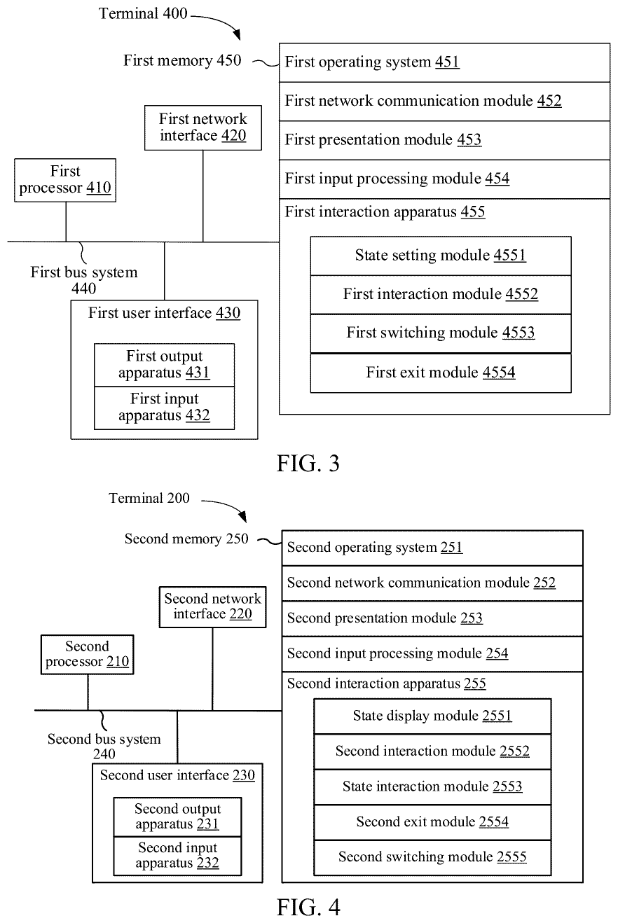

FIG. 3 is a schematic diagram of a structure of a terminal in FIG. 2 according to an aspect of this disclosure. As shown in FIG. 3, a terminal 400 includes: at least one first processor 410, a first memory 450, at least one first network interface 420, and a first user interface 430. All the components in the terminal 400 are coupled together by using a bus system 440. The first bus system 440 is configured to implement connection and communication between the components. In addition to a data bus, the first bus system 440 further includes a power bus, a control bus, and a status signal bus. However, for ease of clear description, all types of buses in FIG. 3 are marked as the first bus system 440.

The first processor 410 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any related processor, or the like.

The first user interface 430 includes one or more first output apparatuses 431 that can display media content, including one or more loudspeakers and/or one or more visual display screens. The first user interface 430 further includes one or more first input apparatuses 432, including a user interface component helping a user input, for example, a keyboard, a mouse, a microphone, a touch display screen, a camera, or another input button and control.

The first memory 450 may be a removable memory, a non-removable memory, or a combination thereof. Example hardware devices include a solid-state memory, a hard disk drive, an optical disc driver, or the like. In some aspects, the first memory 450 includes one or more storage devices physically away from the first processor 410.

The first memory 450 includes a volatile memory or a non-volatile memory, or may include a volatile memory and a non-volatile memory. The non-volatile memory may be a read-only memory (ROM), and the volatile memory may be a random access memory (RAM). The first memory 450 described in the aspects of this disclosure is to include any suitable type of memories.

In some aspects, the first memory 450 can store data to support various operations, examples of which include programs, modules, and data structures, or subsets or supersets thereof, as illustrated below.

A first operating system 451 includes a system program configured to process various basic system services and perform a hardware-related task, for example, a framework layer, a core library layer, and a driver layer, and is configured to implement various basic services and process a hardware-related task.

A first network communication module 452 is configured to reach another electronic device through one or more (wired or wireless) first network interfaces 420. For example, the first network interface 420 includes: Bluetooth, wireless compatible authentication (Wi-Fi), and a universal serial bus (USB).

A first display module 453 is configured to display information by using an output apparatus 431 (for example, a display screen or a speaker) associated with one or more first user interfaces 430 (for example, a user interface configured to operate a peripheral device and display content and information); and

a first input processing module 454 is configured to detect a user input or interaction from one of the one or more first input apparatuses 432 and translate the detected input or interaction.

In some aspects, a first interaction apparatus based on a virtual scene provided in the aspects of this disclosure (referred to as a first interaction apparatus below) can be implemented by software. FIG. 3 shows a first interaction apparatus 455 stored in a first memory 450. The first interaction apparatus may be software in a form such as a program or a plug-in, and includes the following software modules: a state setting module 4551, a first interaction module 4552, a first switching module 4553, and a first exit module 4554. These modules are logical modules, and therefore may be combined in various manners or further divided according to a function to be implemented. A function of each module is described below.

In some aspects, the first interaction apparatus provided in the aspects of the application may be implemented by hardware. For example, the first interaction apparatus provided in the aspects of the disclosure may be a processor in a form of a hardware decoding processor, programmed to perform the interaction method based on a virtual scene that is applied to a first electronic device and that is provided in the aspects of this disclosure. For example, the processor in the form of the hardware decoding processor may use one or more application-specific integrated circuits (ASIC), a DSP, a programmable logic device (PLD), a complex programmable logic device (CPLD), a field-programmable gate array (FPGA), or other electronic components.

FIG. 4 is a schematic diagram of another structure of a terminal in FIG. 2 according to an aspect of this disclosure. As shown in FIG. 4, a terminal 200 includes: at least one second processor 210, a second memory 250, at least one second network interface 220, and a second user interface 230. All the components in the terminal 200 are coupled together by using a bus system 240. The second bus system 240 is configured to implement connection and communication between the components. In addition to a data bus, the second bus system 240 further includes a power bus, a control bus, and a status signal bus. However, for case of clear description, all types of buses in FIG. 4 are marked as the second bus system 240.

The second processor 210 may be an integrated circuit chip having a signal processing capability, for example, a general purpose processor, a digital signal processor, or another programmable logic device, discrete gate, transistor logical device, or discrete hardware component. The general purpose processor may be a microprocessor, any related processor, or the like.

The second user interface 230 includes one or more second output apparatuses 231 that can display media content, including one or more loudspeakers and/or one or more visual display screens. The second user interface 230 further includes one or more second input apparatuses 232, including a user interface component helping a user input, for example, a keyboard, a mouse, a microphone, a touch display screen, a camera, or another input button and control.

The second memory 250 may be a removable memory, a non-removable memory, or a combination thereof. Example hardware devices include a solid-state memory, a hard disk drive, an optical disc driver, or the like. In some aspects, the second memory 250 includes one or more storage devices physically away from the second processor 210.

The second memory 250 includes a volatile memory or a non-volatile memory, or may include a volatile memory and a non-volatile memory. The non-volatile memory may be a read-only memory, and the volatile memory may be a random access memory. The second memory 250 described in the aspects of this disclosure is to include any suitable type of memories.

In some aspects, the second memory 250 can store data to support various operations, examples of which include programs, modules, and data structures, or subsets or supersets thereof, as illustrated below.

A second operating system 251 includes a system program configured to process various basic system services and perform a hardware-related task, for example, a framework layer, a core library layer, and a driver layer, and is configured to implement various basic services and process a hardware-related task.

A second network communication module 252 is configured to reach another electronic device through one or more (wired or wireless) second network interfaces 220. For example, the second network interface 220 includes: Bluetooth, wireless compatible authentication, and a universal serial bus.

A second display module 253 is configured to display information by using an output apparatus 231 (for example, a display screen or a speaker) associated with one or more second user interfaces 230 (for example, a user interface configured to operate a peripheral device and display content and information); and
a second input processing module 254 is configured to detect a user input or interaction from one of the one or more second input apparatuses 232 and translate the detected input or interaction.

In some aspects, a second interaction apparatus based on a virtual scene provided in the aspects of this disclosure (referred to as a second interaction apparatus below) can be implemented by software. FIG. 4 shows a second interaction apparatus 255 stored in a second memory 250. The second interaction apparatus may be software in a form such as a program or a plug-in, and includes the following software modules: a state display module 2551, a second interaction module 2552, a state interaction module 2553, a second exit module 2554, and a second switching module 2555. These modules are logical modules, and therefore may be combined in various manners or further divided according to a function to be implemented. A function of each module is described below.

In some aspects, the second interaction apparatus provided in the aspects of the disclosure may be implemented by hardware. For example, the second interaction apparatus provided in the aspects of the disclosure may be a processor in a form of a hardware decoding processor, programmed to perform the interaction method based on a virtual scene that is applied to a second electronic device and that is provided in the aspects of this disclosure. For example, the processor in the form of the hardware decoding processor may use one or more application-specific integrated circuits, a DSP, a programmable logic device, a complex programmable logic device, a field-programmable gate array, or other electronic components.

In some aspects, the terminal or the server may implement the interaction method based on a virtual scene provided in the aspects of this disclosure by running a computer program. For example, the computer program may be a native program or a software module in an operating system; may be a native application (APP), namely, a program that needs to be installed in an operating system to run, such as an interaction APP or an instant messaging APP; or may be a mini program, namely, a program that only needs to be downloaded into a browser environment to run; or may be a mini program that can be embedded in any APP. In summary, the computer program may be any form of application, module, or plug-in.

The interaction method based on a virtual scene provided in the aspects of this disclosure is described below with reference to an example application and an implementation of a first electronic device and a second electronic device provided in the aspects of this disclosure. In addition, the interaction method based on a virtual scene provided in the aspects of this disclosure is applied to various interaction based on a virtual scene such as a cloud technology, artificial intelligence, smart transportation, and vehicle-mounted interaction.

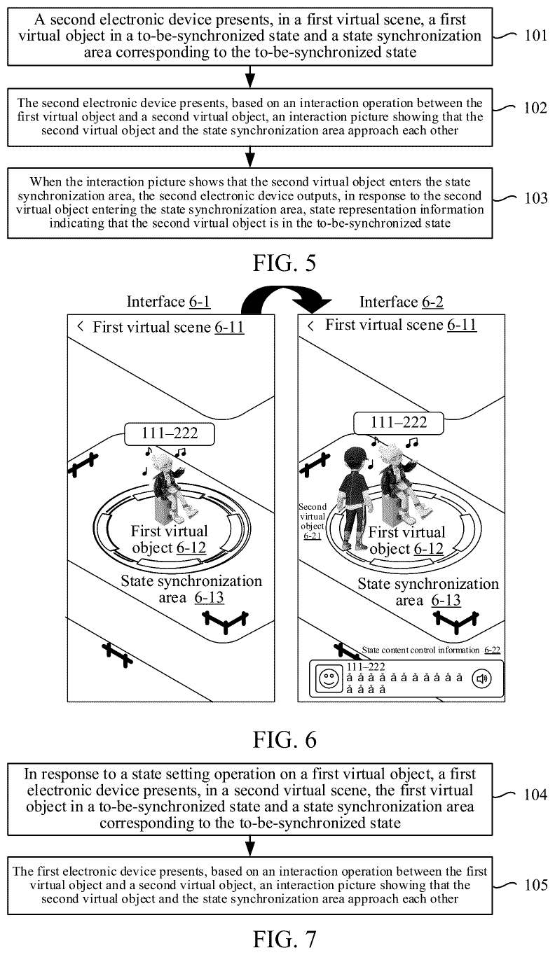

FIG. 5 is a schematic flowchart 1 of an interaction method in a virtual scene according to an aspect of this disclosure. The following provides descriptions with reference to operations shown in FIG. 5. A second electronic device is used as an execution entity.

Operation 101: The second electronic device displays, in a first virtual scene, a first virtual object in a to-be-synchronized state and a state synchronization area corresponding to the to-be-synchronized state. In an example, a first virtual object in a to-be-synchronized state and a state synchronization area are displayed in a first virtual scene. The first virtual object is controlled by a first user associated with a first account.

In the aspects of this disclosure, a virtual scene displayed on the second electronic device side is the first virtual scene. In the first virtual scene, the first virtual object in the to-be-synchronized state is displayed, and the state synchronization area corresponding to the to-be-synchronized state is further displayed; and in the first virtual scene, the second virtual object may be further displayed, or the second virtual object may not be displayed. For example, when a distance between the first virtual object and the second virtual object is less than a distance threshold so that the first virtual object and the second virtual object can be simultaneously displayed in a displayable area, the second virtual object is further displayed in the first virtual scene; and when the distance between the first virtual object and the second virtual object is greater than or equal to the distance threshold, the first virtual object and the second virtual object cannot be simultaneously displayed in the displayable area, and therefore, the second virtual object is not displayed in the first virtual scene.

For example, the first virtual object is associated with a first account, that is, the first virtual object is a virtual object controlled by the first account, which may be a virtual character mapped by the first account, a virtual resource (for example, a virtual pet) owned by the first account, a combination of the two, or the like. This is not limited in the aspects of this disclosure. Control of the first virtual object is implemented through the first account. The second virtual object is associated with a second account, that is, the second virtual object is a virtual object controlled by the second account, which may be a virtual character mapped by the second account, a virtual resource owned by the second account, a combination of the two, or the like. This is not limited in the aspects of this disclosure. Control of the second virtual object is implemented through the second account. The second account completes login on the second electronic device. The second account in a logged-in state controls the second virtual object through the second electronic device.

For example, the to-be-synchronized state represents a state of a virtual object, which is used to reflect a virtual behavior currently being performed by the virtual object, and the to-be-synchronized state includes a synchronization function, where the synchronization function refers to the following function: When one virtual object is in the to-be-synchronized state, another virtual object is assimilated, so that the another virtual object is also in a same state. The to-be-synchronized state is, for example, at least one of an online state, a busy state, a mute state, an away state, an offline state, an audio listening state, and a video viewing state. The audio listening state represents a state in which the virtual object listens to audio information, and the video viewing state represents a state in which the virtual object views video information. The away state is a state in which an account controlling the virtual object does not perform any operation in preset duration. The busy state is a state in which the account controlling the virtual object performs an operation in another application but does not perform an operation on the current virtual object. The offline state is a state in which the account controlling the virtual object logs out of a current application. The mute state is a state in which the account controlling the virtual object sets a current application running an interaction scene to be mute.

Both the first virtual object and the second virtual object are virtual objects. In addition, the first virtual object in the to-be-synchronized state displayed by the first electronic device may be implemented by at least one of the following: text description information (text used to describe a case in which the first virtual object is in the to-be-synchronized state), a virtual action (for example, a music listening action when the to-be-synchronized state is a music listening state and the virtual object sits on a speaker and listens to music) that is performed by the first virtual object and that represents that the first virtual object is in the to-be-synchronized state, and state identification information (for example, at least one of an audio name, an audio author, audio text, an audio cover, a music symbol, and a state icon displayed in a corresponding area of the virtual object when the to-be-synchronized state is the music listening state) displayed in an area based on the first virtual object. The first virtual object is in the to-be-synchronized state, which may indicate that the first account is also in the to-be-synchronized state, or may indicate that the to-be-synchronized state is unrelated to a state of the first account, and the like. This is not limited in the aspects of this disclosure.

In addition, the state synchronization area is configured to trigger synchronization of the to-be-synchronized state between the virtual objects. The state synchronization area is one or two of an object labeling area and an object forming area, where the object labeling area is an area labeled by the first virtual object, and the object forming area is an area formed based on the first virtual object.

For example, if a type of the state synchronization area is the object labeling area, and a labeling manner is selecting a point, the state synchronization area is an area formed by using a point labeled by the account controlling the virtual object at any position in the virtual scene as a center; or the labeling manner is selecting an area, and the state synchronization area is an area circled or labeled in a sliding manner in the virtual scene by the account controlling the virtual object. For another example, if a type of the state synchronization area is the object forming area, the state synchronization area is a circular area formed by using the virtual object as a center, or the virtual scene is divided into a plurality of cells, and the state synchronization area is an area corresponding to a cell in which the virtual object is located.

In addition, the state synchronization area may be a two-dimensional shape (for example, at least one of a circle, a rectangle, an ellipse, a polygon, and a rhombus), a three-dimensional shape (for example, one or two of a cylinder and a cube), a combination of the two, or the like. This is not limited in the aspects of this disclosure. In addition, the state synchronization area may include a state special effect, and the state special effect corresponds to the to-be-synchronized state. For example, if the to-be-synchronized state is the audio listening state, the state special effect is an audio playing special effect. The state special effect is configured for representing that a state that the virtual object is in is the to-be-synchronized state, and in addition, representing that the to-be-synchronized state corresponds to the synchronization function.

Operation 102: The second electronic device displays, based on an interaction operation between the first virtual object and a second virtual object, an interaction picture showing that the second virtual object and the state synchronization area approach each other. In an example, a second virtual object is displayed outside of the state synchronization area in the virtual scene. The second virtual object is controlled by a second user associated with a second account.

In the aspects of this disclosure, the interaction operation represents state synchronization interaction between the first account and the second account, and the interaction operation is configured for controlling the second virtual object to approach the state synchronization area of the first virtual object. In this way, based on the interaction operation, the second electronic device can display the interaction picture showing that the second virtual object and the state synchronization area approach each other.

For example, the interaction operation includes one or two of a first interaction operation and a second interaction operation. The first interaction operation represents a movement operation of controlling, through the first account, the first virtual object to approach the second virtual object, and the state synchronization area moves synchronously with the first virtual object (where the first interaction operation may represent a movement operation of controlling, through the first account, the state synchronization area to approach the second virtual object. In this case, the state synchronization area and the first virtual object may move synchronously or asynchronously). The second interaction operation represents a movement operation of controlling, through the second account, the second virtual object to approach the state synchronization area. In this way, the interaction picture may be a picture showing that the second virtual object approaches the state synchronization area. In this case, the interaction operation includes the second interaction operation. The interaction picture may be further a picture showing that the state synchronization area approaches the second virtual object. In this case, the interaction operation includes the first interaction operation. The interaction picture may be further a picture showing that the second virtual object and the state synchronization area approach each other. In this case, the interaction operation includes the first interaction operation and the second interaction operation. In addition, the first interaction operation is responded to by the first electronic device. The first account completes login on the first electronic device. The first account in a logged-in state controls the first virtual object through the first electronic device.

For example, when the interaction operation includes at least the first interaction operation (may further include the second interaction operation, or may not include the second interaction operation), the state synchronization area moves synchronously with the first virtual object. When the interaction operation includes the second interaction operation but does not include the first interaction operation, the state synchronization area can move synchronously with the first virtual object, or the state synchronization area can be fixed and does not move synchronously with the first virtual object, and the like. This is not limited in the aspects of this disclosure.

Operation 103: When the interaction picture shows that the second virtual object enters the state synchronization area, the second electronic device outputs, in response to the second virtual object entering the state synchronization area, state representation information indicating that the second virtual object is in the to-be-synchronized state. In an example, when the second virtual object enters the state synchronization area, state representation information indicating that the second virtual object is in the to-be-synchronized state is output.

In the aspects of this disclosure, in a process in which the second electronic device displays the interaction picture, when determining that the interaction picture shows that the second virtual object enters the state synchronization area, the second electronic device outputs, in response to the second virtual object entering the state synchronization area, the state representation information indicating that the second virtual object is in the to-be-synchronized state. The state representation information represents representation information indicating that the second virtual object is in the to-be-synchronized state, and may include at least one of the following: text description information (text used to describe a case in which the second virtual object is in the to-be-synchronized state), a virtual action performed by the second virtual object representing that the second virtual object is in the to-be-synchronized state, state content control information (for example, a playing control interface of at least one of audio and a video), information (for example, audio information and video information) output by an output device of the second electronic device, and a description of a state that the second account is in.

For example, state content corresponding to the first virtual object in the to-be-synchronized state and state content corresponding to the second virtual object in the to-be-synchronized state may be consistent or inconsistent. When the state content corresponding to the first virtual object in the to-be-synchronized state and the state content corresponding to the second virtual object are consistent, at least one of the following is included: consistent audio content, consistent video content, and a consistent playing progress.

For example, FIG. 6 is a schematic diagram 1 of an example interaction interface according to an aspect of this disclosure. As shown in FIG. 6, in a first virtual scene 6-11 in an interface 6-1, a first virtual object 6-12 in a to-be-synchronized state, and a state synchronization area 6-13 corresponding to the to-be-synchronized state are displayed. When a second virtual object 6-21 enters the state synchronization area 6-13, as shown in an interface 6-2, state content control information 6-22 is displayed, and at least one of audio information and video information corresponding to the to-be-synchronized state may be further played. In addition, “111-222” represents state identification information.

In aspects of this disclosure, compared with an interaction operation that can be performed requiring consent of accounts corresponding to both a first virtual object and a second virtual object in the related art, an operation of entering the synchronization area by a virtual object implements interaction between virtual objects. A state of the virtual object is synchronized to another virtual object, so that types of interaction operations are enriched, and complexity of the interaction operations is reduced. There is no need to receive and confirm an interaction request. This reduces computing resources required for a processor running a virtual scene to implement the interaction operations, and improves interaction efficiency between the virtual objects.

FIG. 7 is a schematic flowchart 2 of an interaction method in a virtual scene according to an aspect of this disclosure. The following provides descriptions with reference to operations shown in FIG. 7. A first electronic device is used as an execution entity.

Operation 104: In response to a state setting operation on a first virtual object, the first electronic device displays, in a second virtual scene, the first virtual object in a to-be-synchronized state and a state synchronization area corresponding to the to-be-synchronized state.

In aspects of this disclosure, when a user corresponding to a first account sets, through an operation, a state of the first virtual object to the to-be-synchronized state (for example, an operation of selecting the to-be-synchronized state), or when the first electronic device receives a trigger instruction (for example, an automatic test instruction, or a trigger event for setting the to-be-synchronized state) for setting the state of the first virtual object to the to-be-synchronized state, the first electronic device receives a state setting operation on the first virtual object. In this case, the first electronic device sets the state of the first virtual object to the to-be-synchronized state in response to the state setting operation, and displays, in the second virtual scene, the first virtual object in the to-be-synchronized state and the state synchronization area corresponding to the to-be-synchronized state.

For example, a virtual scene displayed on the first electronic device side is the second virtual scene; and a second virtual object may be further displayed in the second virtual scene, or the second virtual object may not be displayed in the second virtual scene. Whether the second virtual object is displayed is similar to a case in the first virtual scene. This is not described herein again in the aspects of this disclosure. In addition, the first virtual object in the to-be-synchronized state displayed by the first electronic device may be implemented by at least one of the following: text description information, a virtual action that is performed by the first virtual object and that represents that the first virtual object is in the to-be-synchronized state, state identification information displayed in an area based on the first virtual object, information (for example, audio information and video information) output by an output device of the first electronic device, and a description of a state that the first account is in. The first virtual object is in the to-be-synchronized state, which may indicate that the first account is also in the to-be-synchronized state, may indicate that the to-be-synchronized state is unrelated to the state of the first account, or the like. This is not limited in the aspects of this disclosure.

Operation 105: The first electronic device displays, based on an interaction operation between the first virtual object and a second virtual object, an interaction picture showing that the second virtual object and the state synchronization area approach each other.

For example, in the process in which the first electronic device displays the interaction picture based on the interaction operation, when the interaction picture shows that the second virtual object enters the state synchronization area, the second electronic device is configured to output state representation information indicating that the second virtual object is in the to-be-synchronized state. In addition, when the second electronic device outputs the state representation information indicating that the second virtual object is in the to-be-synchronized state, the first electronic device may further display synchronization result information; where the synchronization result information represents that a state of the second virtual object is changed to the to-be-synchronized state through the state synchronization area.

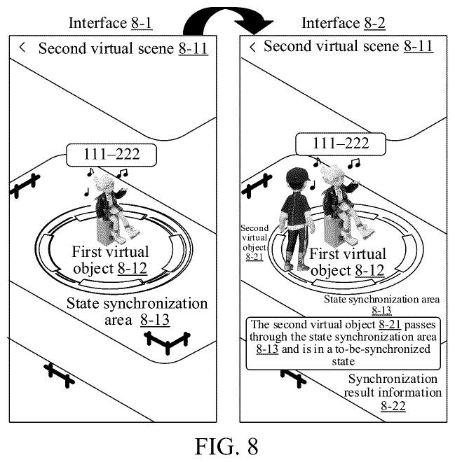

For example, FIG. 8 is a schematic diagram 2 of an example interaction interface according to an aspect of this disclosure. As shown in FIG. 8, in a second virtual scene 8-11 in an interface 8-1, a first virtual object 8-12 in a to-be-synchronized state and a state synchronization area 8-13 corresponding to the to-be-synchronized state are displayed. When a second virtual object 8-21 enters the state synchronization area 8-13, as shown in an interface 8-2, synchronization result information 8-22 is displayed (where the second virtual object 8-21 passes through the state synchronization area 8-13 and is in the to-be-synchronized state).

The first virtual object is associated with a first account, the second virtual object is associated with a second account, and the state synchronization area is displayed when the first virtual object is in the to-be-synchronized state, so that interaction between the first account and the second account is triggered, when the first account and the second account are simultaneously in the to-be-synchronized state, by the second virtual object entering the state synchronization area. In this way, entering the state synchronization area can trigger the interaction between the first account and the second account that are simultaneously in the same to-be-synchronized state. In this way, interaction complexity can be reduced, and interaction efficiency can be improved. In addition, when the interaction between the first account and the second account is implemented through the first virtual object and the second virtual object, a virtual object is combined in the interaction process, so that a state synchronization interaction process can be displayed through the virtual object. This improves a visualization effect of state synchronization, and further improves a visualization effect of interaction.

In the aspects of this disclosure, when the interaction operation includes the second interaction operation, in operation 102, that the second electronic device displays, based on an interaction operation between the first virtual object and a second virtual object, an interaction picture showing that the second virtual object and the state synchronization area approach each other includes: displaying, by the second electronic device in response to the second interaction operation between the first virtual object and the second virtual object, the interaction picture showing that the second virtual object approaches the state synchronization area. In this case, the interaction method based on a virtual scene further includes: generating, by the second electronic device, first interaction data in response to the second interaction operation between the first virtual object and the second virtual object; and transmitting the first interaction data to a first electronic device, to enable the first electronic device to display, based on the first interaction data, the interaction picture showing that the second virtual object approaches the state synchronization area.

For example, the interaction picture may be displayed by the second electronic device in response to the interaction operation. In this case, the interaction operation is the second interaction operation received by the second electronic device. In addition, when displaying an interaction animation in response to the second interaction operation, the second electronic device further transmits first interaction data generated in response to the second interaction operation to the first electronic device, to enable the first electronic device to display the same interaction animation based on the first interaction data when receiving the first interaction data.

For example, the interaction data includes display data, and the display data is configured for displaying the interaction animation. In some aspects, when the interaction operation is an operation that enables the first virtual object and the second virtual object to synchronously listen to music, view a video, and the like, the interaction data may further include audio data or video data.

The second electronic device actively changes, based on the displayed state synchronization area, the state of the second virtual object to the to-be-synchronized state in response to the second interaction operation. This is interaction that actively triggers state synchronization. This improves a success rate of the interaction, further improves effectiveness of the interaction, and reduces resource consumption of the interaction.

In the aspects of this disclosure, when the interaction operation includes the first interaction operation, in operation 102, that the second electronic device displays, based on an interaction operation between the first virtual object and a second virtual object, an interaction picture showing that the second virtual object and the state synchronization area approach each other includes: in response to receiving second interaction data transmitted by a first electronic device, displaying, by the second electronic device based on the second interaction data, the interaction picture showing that both the first virtual object and the state synchronization area approach the second virtual object. The second interaction data is generated by the first electronic device in response to the first interaction operation between the first virtual object and the second virtual object.

For example, the interaction picture may be further displayed by the first electronic device in response to the interaction operation. In this case, the interaction operation is the first interaction operation received by the first electronic device. In addition, when displaying an interaction animation in response to the first interaction operation, the first electronic device further transmits second interaction data generated in response to the first interaction operation to the second electronic device, to enable the second electronic device to display the same interaction animation based on the second interaction data when receiving the second interaction data.

In the aspects of this disclosure, when the interaction operation includes the first interaction operation and the second interaction operation, in operation 102, that the second electronic device displays, based on an interaction operation between the first virtual object and a second virtual object, an interaction picture showing that the second virtual object and the state synchronization area approach each other includes: in response to the second interaction operation and the received second interaction data transmitted by the first electronic device, displaying, by the second electronic device, the interaction picture showing that the state synchronization area and the second virtual object approach each other. Similarly, in response to the first interaction operation and the received first interaction data transmitted by the second electronic device, the first electronic device displays the interaction picture showing that the state synchronization area and the second virtual object approach each other. In this case, the interaction picture is jointly displayed by the first electronic device and the second electronic device in response to the interaction operation.

For example, the first interaction data and the second interaction data may be data directly transmitted between the first electronic device and the second electronic device, or may be data transmitted between the first electronic device and the second electronic device via a server device. This is not limited in the aspects of this disclosure. The server device is a background service device of the first electronic device and the second electronic device.

State synchronization interaction may be triggered by the first electronic device in response to the interaction operation, may be triggered by the second electronic device in response to the interaction operation, or may be jointly triggered by the first electronic device and the second electronic device in response to the interaction operation. In this way, flexibility of the interaction can be improved.

In the aspects of this disclosure, the second virtual object enters the state synchronization area, so that the state of the first virtual object is assimilated with that of the second virtual object. In comparison to an interaction manner in the related art that requires both interaction parties to submit interaction requests, only one operation that the virtual object enters the area is required, and the interaction between the virtual objects can be performed. This improves mutual efficiency, and reduces computing resources required for the interaction between the virtual objects.

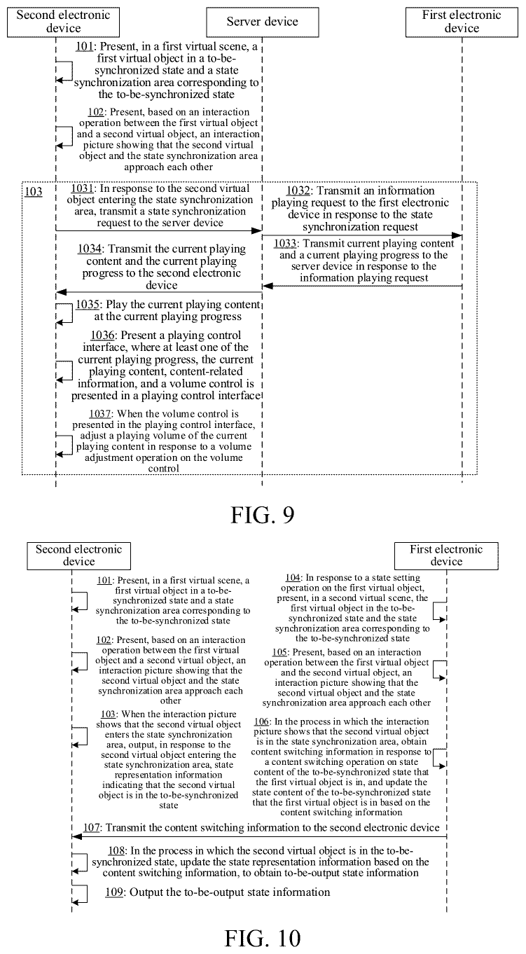

FIG. 9 is an example interaction diagram of a second virtual object entering a state synchronization area according to an aspect of this disclosure. As shown in FIG. 9, in operation 103 in FIG. 5, a second electronic device outputs state representation information indicating that the second virtual object is in a to-be-synchronized state in response to the second virtual object entering the state synchronization area, including operation 1031 to operation 1035, and each operation is described below.

Operation 1031: In response to the second virtual object entering the state synchronization area, the second electronic device transmits a state synchronization request to a server device.

For example, the state synchronization request is configured for requesting that a state of the second virtual object be changed to the to-be-synchronized state. In addition, the state synchronization request includes at least a first account corresponding to the entered state synchronization area and a second account associated with the second virtual object, so that the server device determines state content of the to-be-synchronized state that a first virtual object is in based on the first account, and changes the state of the second virtual object to the to-be-synchronized state that the first virtual object is in based on the second account.

Operation 1032: The server device transmits an information playing request to a first electronic device in response to the state synchronization request.

In aspects of this disclosure, when the second electronic device transmits the state synchronization request to the server device, the server device receives the state synchronization request. In this way, the server device transmits the information playing request to the first electronic device in response to the state synchronization request, to request the first electronic device for current playing information in state content of the to-be-synchronized state that the first virtual object is in. The current playing information includes current playing content and a current playing progress corresponding to the current playing content, for example, at least one of audio information and video information currently played by the first electronic device and a corresponding current playing progress. The current playing content is content played by the first virtual object in the to-be-synchronized state, and the current playing progress is a playing progress of the current playing content.

Operation 1033: The first electronic device transmits the current playing content and the current playing progress to the server device in response to the information playing request.

In the aspects of this disclosure, when the server device transmits the information playing request to the first electronic device, the first electronic device receives the information playing request. In this way, the first electronic device transmits the current playing content and the current playing progress to the server device in response to the information playing request.

Operation 1034: The server device transmits the current playing content and the current playing progress to the second electronic device.

For example, the server device can request the current playing information and the current playing content from the first electronic device, and can further obtain the current playing information and the current playing content based on synchronization data of the server device for the first account. This is not limited in the aspects of this disclosure.

Operation 1035: The second electronic device plays the current playing content according to the current playing progress.

For example, the state representation information indicating that the second virtual object is in the to-be-synchronized state includes playing the current playing content according to the current playing progress.

In the aspects of this disclosure, the second electronic device transmits the state synchronization request to the server device, so that the obtained content may be further the current playing content. In this way, in this case, the second electronic device plays the current playing content. In other words, through state synchronization interaction, the first electronic device and the second electronic device may play the same content, or play the same content at the same playing progress. This is not limited in the aspects of this disclosure.

In the aspects of this disclosure, through state synchronization, content played in different electronic devices is set to be consistent, and playing progresses in different electronic devices may be further set to be consistent. This improves fun of the interaction between the virtual objects in the virtual scene, and improves efficiency of man-machine interaction.

Still referring to FIG. 9, after operation 1034 operation 1036 and operation 1037 are further included. In other words, after receiving, in response to the state synchronization request, the state synchronization result transmitted by the server device, the interaction method based on a virtual scene further includes operation 1036 and operation 1037, and each operation is separately described below.

Operation 1036: The second electronic device displays a playing control interface, where at least one of the current playing progress, the current playing content, content-related information, and a volume control is displayed in the playing control interface.

For example, the content-related information is related information of the current playing content, such as at least one of a name of the playing content, a content providing object, a content cover picture, and content details; the volume control is configured to control a playing volume of the current playing content; and the state representation information further includes the playing control interface.

Operation 1037: When the volume control is displayed in the playing control interface, the second electronic device adjusts the playing volume of the current playing content in response to a volume adjustment operation on the volume control.

In the aspects of this disclosure, when the volume control is displayed in the playing control interface, and when the user triggers the volume control through the second account to perform volume adjustment, or receives an automated instruction to trigger the volume control, the second electronic device receives the volume adjustment operation on the volume control. In this case, the second electronic device adjusts a playing volume of the current playing content in response to the volume adjustment operation, where adjustment of the playing volume includes switch adjustment of the volume, level adjustment of the volume, and the like.

In the aspects of this disclosure, in operation 103 in FIG. 5, that the second electronic device outputs state representation information indicating that the second virtual object is in the to-be-synchronized state in response to the second virtual object entering the state synchronization area includes: displaying, by the second electronic device, permission prompt information in response to the second virtual object entering the state synchronization area; next, in response to an obtaining success operation on the permission prompt information, outputting, by the second electronic device, the state representation information indicating that the second virtual object is in the to-be-synchronized state; and in response to an obtaining failure operation on the permission prompt information, displaying, by the second electronic device, a picture showing that the second virtual object is outside the state synchronization area, and ending the control of changing the state of the second virtual object to the to-be-synchronized state.

For example, in response to the second virtual object entering the state synchronization area, the second electronic device first determines whether the second virtual object has permission to enter the to-be-synchronized state. The permission to enter the to-be-synchronized state refers to permission to obtain state content of the to-be-synchronized state that the first virtual object is in. The permission prompt information represents prompt information of obtaining permission, and the permission to obtain the state content of the to-be-synchronized state that the first virtual object is in is obtained through the permission prompt information. The obtaining success operation represents that the permission to control the second virtual object to enter the to-be-synchronized state is successfully obtained, such as a permission transaction operation (representing an operation of obtaining the permission through a transaction), a permission application operation (representing an operation of applying for the permission), and the like. The obtaining failure operation represents that obtaining of the permission to control the second virtual object to enter the to-be-synchronized state fails, which may be canceling a permission obtaining operation, an erroneous permission obtaining operation, or the like. This is not limited in the aspects of this disclosure.

In the aspects of this disclosure, the displaying, by the second electronic device, permission prompt information in response to the second virtual object entering the state synchronization area includes: in response to the second virtual object entering the state synchronization area, transmitting, by the second electronic device, a permission determining request carrying the second account to the server device; receiving a permission determining result transmitted by the server device in response to the permission determining request; displaying the permission prompt information when the permission determining result represents that the second virtual object has no permission to be in the to-be-synchronized state; and when the permission determining result represents that the second virtual object includes the permission to be in the to-be-synchronized state, directly outputting the state representation information indicating that the second virtual object is in the to-be-synchronized state.

For example, displaying of the permission prompt information is triggered when the second virtual object or the second account has no permission to obtain the state content of the to-be-synchronized state that the first virtual object is in. The permission determining request is configured for requesting to determine, based on the second account, whether the second virtual object has the permission to be in the to-be-synchronized state. When the second virtual object has the permission, the second electronic device outputs the state representation information indicating that the second virtual object is in the to-be-synchronized state, or otherwise the state synchronization interaction is ended. In this case, prompt information of interaction failure may be further displayed.

FIG. 10 is a schematic flowchart 3 of an interaction method in a virtual scene according to an aspect of this disclosure. As shown in FIG. 10, in the aspects of this disclosure, in operation 103 in FIG. 5, after the second electronic device outputs the state representation information indicating that the second virtual object is in the to-be-synchronized state in response to the second virtual object entering the state synchronization area, and in operation 105 in FIG. 7, after the first electronic device displays, based on the interaction operation between the first virtual object and the second virtual object, the interaction picture showing that the second virtual object and the state synchronization area approach each other, the interaction method based on a virtual scene further includes operation 106 to operation 109, and each operation is separately described below.

Operation 106: In the process in which the interaction picture shows that the second virtual object is in the state synchronization area, the first electronic device obtains content switching information in response to a content switching operation on state content of the to-be-synchronized state that the first virtual object is in, and updates the state content of the to-be-synchronized state that the first virtual object is in based on the content switching information.

For example, the content switching operation is configured for switching the state content of the to-be-synchronized state that the first virtual object is in, and the content switching information refers to the state content of the to-be-synchronized state that the first virtual object is in after the content switching.

Operation 107: The first electronic device transmits the content switching information to the second electronic device.

For example, the first electronic device transmits the content switching information to the second electronic device, to enable the second electronic device to update, based on the content switching information, the output state representation information, thereby implementing synchronous update of the state content.

Operation 108: In the process in which the second virtual object is in the to-be-synchronized state, the second electronic device updates the state representation information based on the content switching information, to obtain to-be-output state information.

In the aspects of this disclosure, when the first electronic device transmits the content switching information to the second electronic device, the second electronic device receives the content switching information transmitted by the first electronic device. Because the content switching information is generated by the first electronic device in response to the content switching operation on the to-be-synchronized state, and the state content of the to-be-synchronized state that the second virtual object is in is consistent with the state content of the to-be-synchronized state that the first virtual object is in, the second electronic device updates the output state representation information based on the content switching information. The to-be-output state information is the updated state representation information.

Operation 109: The second electronic device outputs the to-be-output state information.

For example, after obtaining the to-be-output state information by updating the state representation information, the second electronic device outputs the to-be-output state information, to continue to be consistent with the state content of the first virtual object.

In the aspects of this disclosure, in operation 103, after the second electronic device outputs the state representation information indicating that the second virtual object is in the to-be-synchronized state in response to the second virtual object entering the state synchronization area, and in operation 105, after the first electronic device displays, based on the interaction operation between the first virtual object and the second virtual object, the interaction picture showing that the second virtual object and the state synchronization area approach each other, the interaction method based on a virtual scene further includes a process of ending the state synchronization interaction, where the process includes: displaying, by the second electronic device, a separation animation of the second virtual object and the state synchronization area based on a separation operation of the second virtual object and the state synchronization area, and ends the output of the state representation information in response to the separation animation representing separation between the second virtual object and the state synchronization area. Alternatively, in the process in which the interaction picture shows that the second virtual object is in the state synchronization area, the first electronic device transmits a state exit message to the second electronic device in response to a state exit operation of controlling the first virtual object to exit the to-be-synchronized state, to enable the second electronic device to end, based on the state exit message, the output of the state representation information. In this way, the second electronic device ends the output of the state representation information in response to the received state exit message transmitted by the first electronic device. The state exit message is generated by the first electronic device in response to a state exit operation, and the state exit operation represents an operation of controlling the first virtual object to exit the to-be-synchronized state.

For example, the separation operation includes one or two of a first separation operation and a second separation operation. The first separation operation represents a movement operation of controlling, through a first account, both the first virtual object and the state synchronization area to move away from the second virtual object, and the second separation operation represents a movement operation of controlling, through a second account, the second virtual object to move away from the state synchronization area.

In the aspects of this disclosure, when the separation operation is the first separation operation, in the process in which the interaction picture shows that the second virtual object is in the state synchronization area, in response to the first separation operation, the first electronic device transmits a separation message to the second electronic device. In this case, the second electronic device displays, based on the separation message, the separation animation in which the state synchronization area moves away from the second virtual object, and ends the output of the state representation information in response to the separation animation representing the separation between the second virtual object and the state synchronization area.

In the aspects of this disclosure, when the separation operation is the second separation operation, in the process in which the interaction picture shows that the second virtual object is in the state synchronization area, the second electronic device displays, in response to the second separation operation, the separation animation in which the second virtual object moves away from the state synchronization area, transmits an active separation message to the first electronic device, and ends the output of the state representation information in response to the separation animation representing the separation between the second virtual object and the state synchronization area. In this case, the first electronic device displays, based on the active separation message, the separation animation in which the second virtual object moves away from the state synchronization area, and displays state synchronization end prompt information when the separation animation represents the separation between the second virtual object and the state synchronization area.

In the aspects of this disclosure, when the separation operation includes the first separation operation and the second separation operation, the separation animation is an animation in which the second virtual object and the state synchronization area move away from each other.

The following describes an example application of this aspect of this disclosure in an actual application scenario. The example application describes a process in which two accounts listens to music together through interaction of respective virtual characters.

In the aspects of this disclosure, state synchronization between the virtual object and another virtual object is implemented by the virtual object entering the state synchronization area, and the state synchronization between the virtual object and the another virtual object is released by the virtual object moving away from the state synchronization area. This improves interaction efficiency, and improves a degree of freedom of interaction between the virtual objects in the virtual scene.

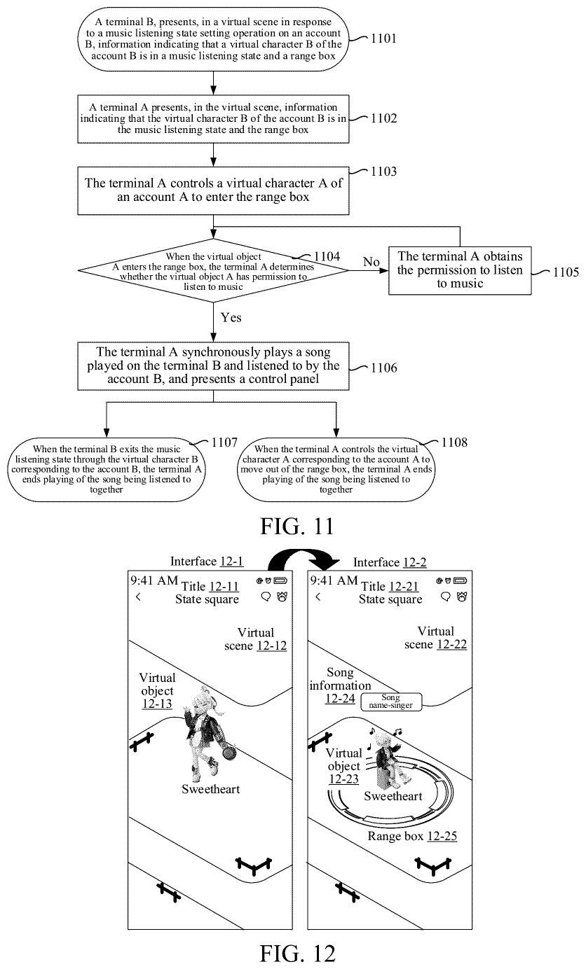

FIG. 11 is an example schematic flowchart of listening to music together according to an aspect of this disclosure. As shown in FIG. 11, the example schematic flowchart of listening to music together includes operation 1101 to operation 1110, and each operation is separately described below.

Operation 1101: A terminal B (referred to as a first electronic device), displays, in a virtual scene (referred to as a second virtual scene) in response to a music listening state setting operation (referred to as a state setting operation) on an account B (a first account), information indicating that a virtual character B (referred to as a first virtual object) of the account B is in a music listening state (referred to as a to-be-synchronized state) and a range box (referred to as a state synchronization area).

For example, when a user B starts listening to music in the virtual scene through the terminal B, the terminal B receives the music listening state setting operation on the account B. In response to the music listening state setting operation, the terminal B displays the virtual character B whose character state is listening to music in the virtual scene, displays a name and a singer of a song being listened to, and displays a range box with an animation special effect centered on the virtual character B.

For example, FIG. 12 is a schematic diagram of state setting according to an aspect of this disclosure. As shown in FIG. 12, in an interface 12-1, a title 12-11 and a virtual scene 12-12 are displayed. In the virtual scene 12-12, a virtual object 12-13 (a virtual character B “sweetheart”, referred to as a first virtual character) is displayed. In response to a music listening state setting operation on the virtual object 12-13, as shown in an interface 12-2, a title 12-21 and a virtual scene 12-22 are displayed. In the virtual scene 12-22, a virtual object 12-23 (the virtual character B “sweetheart”, referred to as the first virtual character) whose character state is listening to music is displayed. Song information 12-24 (song name-singer), a range box 12-25 with an animation effect, and a music symbol corresponding to the virtual object 12-23 are further displayed.

Operation 1102: A terminal A (referred to as a second electronic device) displays information indicating that a virtual character B of an account B is in a music listening state and a range box in the virtual scene (referred to as a first virtual scene).

For example, content displayed on the terminal A is the same as that displayed on the terminal B. The terminal A also displays information indicating that the virtual character B of the account B is in the music listening state and the range box in the virtual scene.

Operation 1103: The terminal A controls a virtual character A (referred to as a second virtual object) of an account A (referred to as a second account) to enter the range box.

For example, a user A controls the virtual character A of the account A through the terminal A to move into the range box.

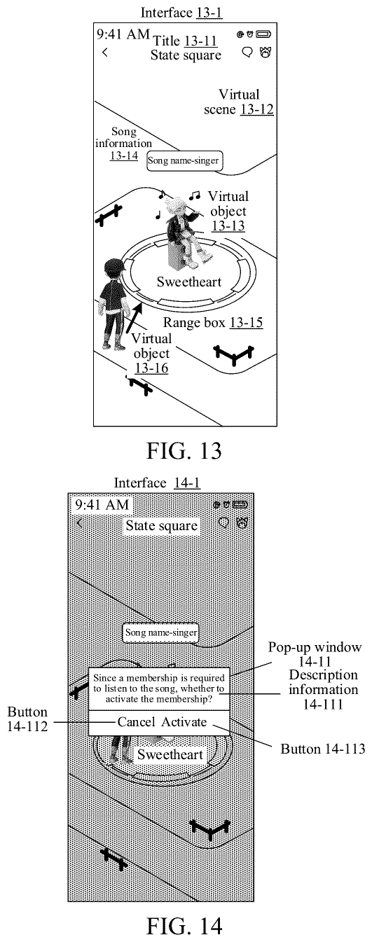

For example, FIG. 13 is a schematic diagram of an example trigger state change according to an aspect of this disclosure. As shown in FIG. 13, in an interface 13-1, a title 13-11 and a virtual scene 13-12 are displayed. In the virtual scene 13-12, a virtual object 13-13 (a virtual character B “sweetheart”, referred to as a first virtual character) whose character state is listening to music is displayed, song information 13-14 and a range box 13-15 with an animation effect are further displayed, and a virtual object 13-16 (namely, a virtual character A) is further displayed; and the virtual object 13-16 gradually moves toward the range box 13-15 in the virtual scene 13-12 to enter the range box 13-15.

Operation 1104: When the virtual object A enters the range box, the terminal A determines whether the virtual object A has permission to listen to music. If yes, operation 1106 is performed, or if not, operation 1105 is performed.

For example, when the virtual object A enters the range box, the terminal A is triggered to determine the permission to listen to music.

Operation 1105: The terminal A obtains the permission to listen to music. Then, operation 1104 is performed.

For example, when determining that the account A has no permission to listen to music, the terminal A displays prompt information (referred to as permission prompt information). FIG. 14 is an example schematic diagram of displaying prompt information according to an aspect of this disclosure. As shown in FIG. 14, a pop-up window 14-11 is displayed in an interface 14-1. The pop-up window 14-11 includes description information 14-111 (since a membership is required to listen to the song, whether to activate the membership?), a button 14-112 (a “cancel” button), and a button 14-113 (an “activate” button) for obtaining permission. When the button 14-113 is triggered, operation 1105 is performed; and when the button 14-112 is triggered, an animation of the virtual object A moving out of the range box is displayed.

Operation 1106: A terminal A synchronously plays a song played on a terminal B and listened to by an account B, and displays a control panel. Then, operation 1107 or operation 1108 is performed.

For example, when an account A has the permission to listen to music, it indicates that the account A can listen to the song listened to by the account B. In this way, the terminal A synchronously plays the song listened to by the account B on the terminal B, and displays the control panel. A playing progress of the terminal A is consistent with a playing progress of the terminal B, the control panel is configured to control opening and closing of a song sound, and the control panel is further configured to display a cover, a name, a singer and lyrics of the song.

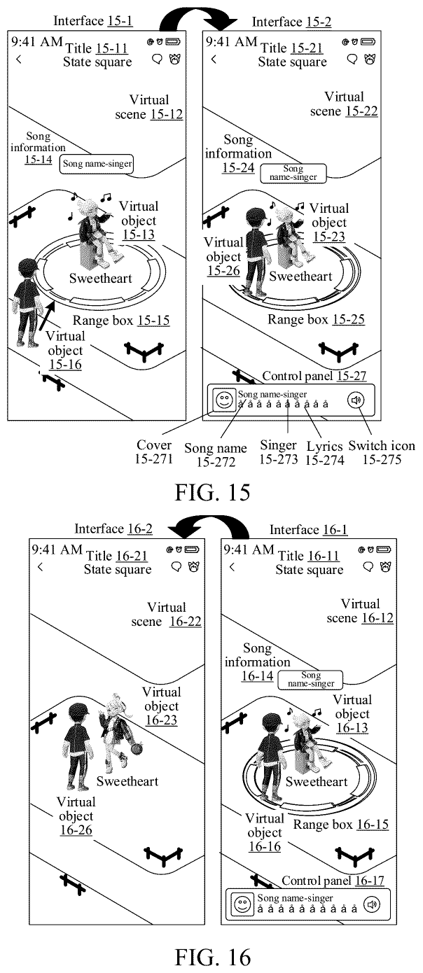

For example, FIG. 15 is an example schematic diagram of synchronously listening to music according to an aspect of this disclosure. As shown in FIG. 15, in an interface 15-1, a title 15-11 and a virtual scene 15-12 are displayed. In the virtual scene 15-12, a virtual object 15-13 (“sweetheart”, referred to as a virtual character B) whose character state is listening to music is displayed, song information 15-14 and a range box 15-15 with an animation effect are further displayed, and a virtual object 15-16 (namely, a virtual character A) is further displayed. When the virtual object 15-16 gradually moves toward the range box 15-15 in the virtual scene 15-12 and enters the range box 15-15, and an account A has permission to listen to music for the song information 15-14, as shown in the interface 15-2, in the interface 15-2, a title 15-21 and a virtual scene 15-22 are displayed. In the virtual scene 15-22, a virtual object 15-23 (“sweetheart”, referred to as the virtual character B) whose character state is listening to music is displayed, song information 15-24 and a range box 15-25 with an animation effect are further displayed, a virtual object 15-26 (namely, the virtual character A) located in the range box 15-25 is further displayed, and a control panel 15-27 (referred to as a playing control interface) is further displayed. The control panel 15-27 displays a song cover 15-271, a song name 15-272, a singer 15-273, lyrics 15-274, and a switch icon 15-275 for a song playing sound, and may further include a playing progress.

Operation 1107: When a terminal B exits a music listening state through a virtual character B corresponding to an account B, the terminal A ends playing of a song being listened to together.

For example, ending of the playing of the song performed by the terminal A can be triggered by an event of the virtual character B exiting the music listening state. For example, FIG. 16 is an example schematic diagram of exiting from a music listening state according to an aspect of this disclosure. As shown in FIG. 16, in an interface 16-1, a title 16-11 and a virtual scene 16-12 are displayed. In the virtual scene 16-12, a virtual object 16-13 (“sweetheart”, referred to as the virtual character B) whose character state is listening to music is displayed, song information 16-14 and a range box 16-15 with an animation effect are further displayed, a virtual object 16-16 (referred to as a virtual character A) located in the range box 16-15 is further displayed, and a control panel 16-17 is further displayed. When a terminal B changes a state of the virtual character B from a music listening state to a normal state in response to a music state exit operation, as shown in an interface 16-2, in the interface 16-2, a title 16-21 and a virtual scene 16-22 are displayed. In the virtual scene 16-22, a virtual object 16-23 (“sweetheart”, referred to as a virtual character B) whose character state is the normal state is displayed, and a virtual object 16-26 (referred to as the virtual character A) whose character state is the normal state is further displayed. In the interface 16-2, the song information 16-14, the range box 16-15 with the animation effect, and the control panel 16-17 in the interface 16-1 have disappeared.

Operation 1108: When a terminal A controls a virtual character A corresponding to an account A to move out of the range box, the terminal A ends playing of a song being listened to together.

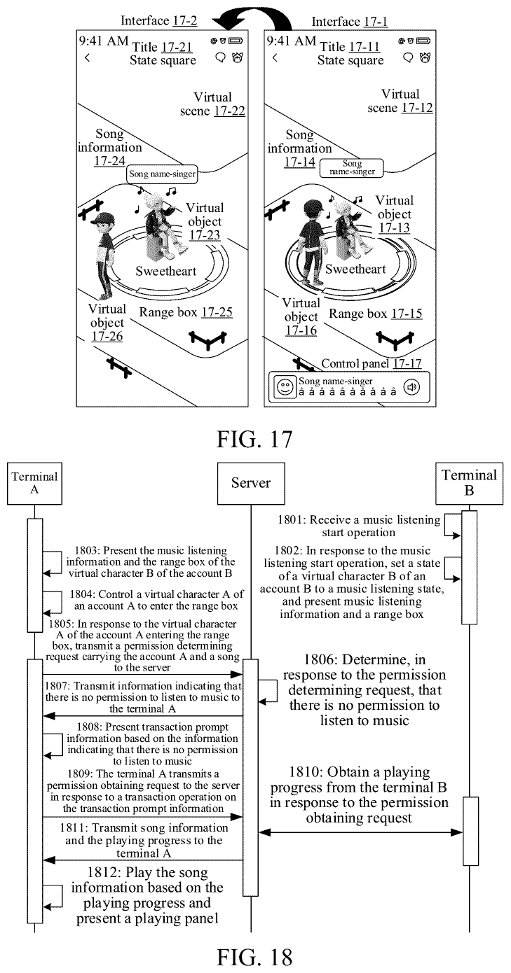

For example, ending of the playing of the song performed by the terminal A can also be triggered by an event that the virtual character A moves out of the range box. For example, FIG. 17 is another example schematic diagram of exiting from a music listening state according to an aspect of this disclosure. As shown in FIG. 17, in an interface 17-1, a title 17-11 and a virtual scene 17-12 are displayed. In the virtual scene 17-12, a virtual object 17-13 (“sweetheart”, referred to as the virtual character B) whose character state is listening to music is displayed, song information 17-14 and a range box 17-15 with an animation effect are further displayed, a virtual object 17-16 (referred to as a virtual character A) located in the range box 17-15 is further displayed, and a control panel 17-17 is further displayed. When the terminal A controls the virtual character A to move out of the range box, as shown in an interface 17-2, in the interface 17-2, a title 17-21 and a virtual scene 17-22 are displayed. In the virtual scene 17-22, a virtual object 17-23 (“sweetheart”, referred to as a virtual character B) whose character state is listening to music is displayed, song information 17-24 and a range box 17-25 with an animation effect are further displayed, and a virtual object 17-26 (referred to as a virtual character A) whose character state is a normal state is further displayed. In the interface 17-2, the control panel 17-17 in the interface 17-1 has disappeared.

Based on FIG. 11, FIG. 18 is an example schematic diagram of interaction of listening to music together according to an aspect of this disclosure. As shown in FIG. 18, the example interaction process of listening to music together includes operation 1801 to operation 1812, and each operation is separately described below.

Operation 1801: A terminal B receives a music listening start operation (referred to as a music listening state setting operation).

Operation 1802: In response to the music listening start operation, the terminal B sets a state of a virtual character B of an account B to a music listening state, and displays music listening information and a range box.

Operation 1803: A terminal A displays the music listening information and the range box of the virtual character B of the account B.

Operation 1804: The terminal A controls a virtual character A of an account A to enter the range box.

Operation 1805: In response to a virtual character A of an account A entering the range box, the terminal A transmits a permission determining request carrying the account A and a song to a server (referred to as a server device).

Operation 1806: The server determines, in response to the permission determining request, that there is no permission to listen to music.

Operation 1807: The server transmits information indicating that there is no permission to listen to music to the terminal A.

Operation 1808: The terminal A displays transaction prompt information (referred to as permission prompt information) based on the information indicating that there is no permission to listen to music.

Operation 1809: The terminal A transmits a permission obtaining request to the server in response to a transaction operation on the transaction prompt information.

Operation 1810: The server obtains a playing progress (referred to as a current playing progress) from the terminal B in response to the permission obtaining request.

Operation 1811: The server transmits song information (referred to as current playing content) and the playing progress to the terminal A.

Operation 1812: The terminal A plays the song information based on the playing progress and displays a playing panel.

The aspects of this disclosure provide a manner of listening to music together in a virtual scene, to implement interactive music listening in an active manner. In addition, because the virtual character is mapping of an account in the virtual scene, interaction is visualized by combining the virtual character with the virtual scene, thereby improving an interaction effect. In addition, the range box is entered, so that music listening and interaction can be implemented. This improves efficiency of interaction, and reduces resource consumption of the music listening and interaction.

The following continues to describe an example structure in which a first interaction apparatus 455 provided in the aspects of this disclosure is implemented as a software module. In some aspects, as shown in FIG. 3, a software module stored in a first interaction apparatus 455 of a first memory 450 may include:
a state setting module 4551, configured to: in response to a state setting operation on a first virtual object, display, in a second virtual scene, the first virtual object in a to-be-synchronized state and a state synchronization area corresponding to the to-be-synchronized state, the first virtual object corresponding to a first account; and
a first interaction module 4552, configured to display, based on an interaction operation between the first virtual object and a second virtual object, an interaction picture showing that the second virtual object and the state synchronization area approach each other, the second virtual object corresponding to a second account, the interaction operation representing interaction between the first account and the second account, and when the interaction picture shows that the second virtual object enters the state synchronization area, the second electronic device being configured to output state representation information indicating that the second virtual object is in the to-be-synchronized state, and the second electronic device being an electronic device logged in by the second account.

In the aspects of this disclosure, the first interaction apparatus 455 further includes a first switching module 4553, configured to: in the process in which the interaction picture shows that the second virtual object is in the state synchronization area, obtain content switching information in response to a content switching operation on state content of the to-be-synchronized state that the first virtual object is in; and transmit the content switching information to the second electronic device, to enable the second electronic device to update, based on the content switching information, the output state representation information.

In the aspects of this disclosure, the first interaction apparatus 455 further includes a first exit module 4554, configured to: in the process in which the interaction picture shows that the second virtual object is in the state synchronization area, transmit a state exit message to the second electronic device in response to a state exit operation of controlling the first virtual object to exit the to-be-synchronized state, to enable the second electronic device to end, based on the state exit message, the output of the state representation information; or in the process in which the interaction picture shows that the second virtual object is in the state synchronization area, in response to a first separation operation, display a separation animation in which the state synchronization area moves away from the second virtual object, and transmit a separation message to the second electronic device, to enable the second electronic device to display, based on the separation message, the separation animation in which the state synchronization area moves away from the second virtual object, and end the output of the state representation information in response to the separation animation representing the separation between the second virtual object and the state synchronization area, where the first separation operation represents a movement operation of controlling, through the first account, both the first virtual object and the state synchronization area to move away from the second virtual object.

The following continues to describe an example structure in which a second interaction apparatus 255 provided in the aspects of this disclosure is implemented as a software module. In some aspects, as shown in FIG. 4, a software module stored in a second interaction apparatus 255 of a second memory 250 may include:
a state display module 2551, configured to display, in a first virtual scene, a first virtual object in a to-be-synchronized state and a state synchronization area corresponding to the to-be-synchronized state, the first virtual object being associated with a first account;
a second interaction module 2552, configured to display, based on an interaction operation between the first virtual object and a second virtual object, an interaction picture showing that the second virtual object and the state synchronization area approach each other, the second virtual object being associated with a second account, and the interaction operation representing interaction between the first account and the second account; and
a state interaction module 2553, configured to: when the interaction picture shows that the second virtual object enters the state synchronization area, output, in response to the second virtual object entering the state synchronization area, state representation information indicating that the second virtual object is in the to-be-synchronized state.

In the aspects of this disclosure, the to-be-synchronized state includes at least one of an audio listening state and a video viewing state, where the audio listening state represents a state in which a virtual object listens to audio information, the video viewing state represents a state in which the virtual object views video information, and both the first virtual object and the second virtual object are the virtual objects.

In the aspects of this disclosure, the interaction operation includes one or two of a first interaction operation and a second interaction operation, where the first interaction operation represents a movement operation of controlling, through the first account, the first virtual object to approach the second virtual object, the state synchronization area moves synchronously with the first virtual object, and the second interaction operation represents a movement operation of controlling, through the second account, the second virtual object to approach the state synchronization area.

In the aspects of this disclosure, when the interaction operation includes the second interaction operation, the second interaction module 2552 is further configured to: in response to the second interaction operation between the first virtual object and the second virtual object, display the interaction picture showing that the second virtual object approaches the state synchronization area, where the second interaction operation is responded by a second electronic device, and the second electronic device is an electronic device logged in by the second account; generate first interaction data in response to the second interaction operation between the first virtual object and the second virtual object; and transmit the first interaction data to a first electronic device, to enable the first electronic device to display, based on the first interaction data, the interaction picture showing that the second virtual object approaches the state synchronization area.

In the aspects of this disclosure, when the interaction operation includes the first interaction operation, the second interaction module 2552 is further configured to: in response to receiving second interaction data transmitted by a first electronic device, display, based on the second interaction data, the interaction picture showing that both the first virtual object and the state synchronization area approach the second virtual object, where the second interaction data is generated by the first electronic device in response to the first interaction operation between the first virtual object and the second virtual object, and the first electronic device is an electronic device logged in by the first account.

In the aspects of this disclosure, the state interaction module 2553 is further configured to: in response to the second virtual object entering the state synchronization area, transmit a state synchronization request to a server device, where the server device is a background service device of a first electronic device and a second electronic device, and the state synchronization request is configured for requesting to change a state of the second virtual object to the to-be-synchronized state; receive current playing content and a current playing progress transmitted by the server device in response to the state synchronization request; and play the current playing content according to the current playing progress, where the current playing content is content played by the first virtual object in the to-be-synchronized state, the current playing progress is a playing progress of the current playing content, and the state representation information indicating that the second virtual object is in the to-be-synchronized state includes playing the current playing content according to the current playing progress.

In the aspects of this disclosure, the state interaction module 2553 is further configured to display a playing control interface, where at least one of the current playing progress, the current playing content, content-related information, and a volume control is displayed in the playing control interface, the content-related information is related information of the current playing content, and the state representation information further includes the playing control interface; and when the volume control is displayed in the playing control interface, adjust a playing volume of the current playing content in response to a volume adjustment operation on the volume control.

In the aspects of this disclosure, the state interaction module 2553 is further configured to: display permission prompt information in response to the second virtual object entering the state synchronization area, where the permission prompt information represents prompt information of obtaining permission; and in response to an obtaining success operation on the permission prompt information, output the state representation information indicating that the second virtual object is in the to-be-synchronized state, where the obtaining success operation represents that permission to control the second virtual object to enter the to-be-synchronized state is successfully obtained.

In the aspects of this disclosure, the state interaction module 2553 is further configured to: in response to the second virtual object entering the state synchronization area, transmit a permission determining request carrying the second account to the server device, where the permission determining request is configured for requesting to determine, based on the second account, whether the second virtual object has the permission to be in the to-be-synchronized state; receive a permission determining result transmitted by the server device in response to the permission determining request; and display the permission prompt information when the permission determining result represents that the second virtual object has no permission to be in the to-be-synchronized state.

In the aspects of this disclosure, the state interaction module 2553 is further configured to: in response to an obtaining failure operation on the permission prompt information, display an a picture showing that the second virtual object is outside the state synchronization area, and end the control of changing the state of the second virtual object to the to-be-synchronized state, where the obtaining failure operation represents that obtaining of the permission to control the second virtual object to enter the to-be-synchronized state fails.

In the aspects of this disclosure, the second interaction apparatus 255 further includes a second exit module 2554, configured to: based on a separation operation on the second virtual object and the state synchronization area, display a separation animation of the second virtual object and the state synchronization area, and end the output of the state representation information in response to the separation animation representing separation between the second virtual object and the state synchronization area, where the separation operation includes one or two of a first separation operation and a second separation operation, the first separation operation represents a movement operation of controlling, through the first account, both the first virtual object and the state synchronization area to move away from the second virtual object, and the second separation operation represents a movement operation of controlling, through the second account, the second virtual object to move away from the state synchronization area; or end the output of the state representation information in response to receiving a state exit message transmitted by the first electronic device, where the state exit message is generated by the first electronic device in response to a state exit operation, and the state exit operation represents an operation of controlling the first virtual object to exit the to-be-synchronized state.

In the aspects of this disclosure, the second interaction apparatus 255 further includes a second switching module 2555, configured to: in the process in which the second virtual object is in the to-be-synchronized state, receive content switching information transmitted by the first electronic device, where the content switching information is generated by the first electronic device in response to a content switching operation on the to-be-synchronized state, and the content switching operation is configured for switching state content of the to-be-synchronized state that the first virtual object is in; update the state representation information based on the content switching information, to obtain to-be-output state information; and output the to-be-output state information.

In the aspects of this disclosure, the state synchronization area is one or two of an object labeling area and an object forming area, where the object labeling area is an area labeled by the first virtual object, and the object forming area is an area formed based on the first virtual object.

The aspects of this disclosure provide a computer program product. The computer program product includes a computer program or computer-executable instructions. The computer program or computer-executable instructions are stored in a computer-readable storage medium. A first processor of a first electronic device reads the computer-executable instructions from the computer-readable storage medium, and the first processor executes the computer-executable instructions, to enable the first electronic device to perform the interaction method based on a virtual scene applied to the first electronic device in the aspects of this disclosure. A second processor of a second electronic device reads the computer-executable instructions from the computer-readable storage medium, and the second processor executes the computer-executable instructions, to enable the second electronic device to perform the interaction method based on a virtual scene applied to the second electronic device in the aspects of this disclosure.

The aspects of this disclosure provide a computer-readable storage medium, having computer-executable instructions stored therein, the computer-executable instructions, when executed by a first processor, causing the first processor to perform the interaction method based on a virtual scene applied to a first electronic device that is provided in the aspects of this disclosure, for example, the method based on a virtual scene applied to the first electronic device shown in FIG. 7; or the computer-executable instructions, when executed by a second processor, causing the second processor to perform the interaction method based on a virtual scene applied to a second electronic device that is provided in the aspects of this disclosure, for example, the method based on a virtual scene applied to the second electronic device shown in FIG. 5.

In some aspects, the computer-readable storage medium may be a memory such as an FRAM, a ROM, a PROM, an EPROM, an EEPROM, a flash memory, a magnetic surface memory, a compact disc, or a CD-ROM; or may be various devices including one of or any combination of the foregoing memories.

In some aspects, the computer-executable instructions may be written in the form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hyper text markup language (HTML) file, stored in a file that is specially used for a program in discussion, or stored in a plurality of collaborative files (for example, be stored in files of one or more modules, subprograms, or code parts).

As an example, the computer-executable instructions may be deployed on one electronic device for execution (where in this case, the electronic device is a first electronic device and a second electronic device), or executed on a plurality of electronic devices located at one location (where in this case, the plurality of electronic devices located at one location are a first electronic device and a second electronic device), or executed on a plurality of electronic devices distributed at a plurality of locations and interconnected through a communication network (where in this case, the plurality of electronic devices distributed at plurality of locations and interconnected through the communication network are the first electronic device and the second electronic device).

In the aspects of this disclosure, data related to a to-be-synchronized state and state content are related. When the aspects of this disclosure are applied to specific products or technologies, user permission or consent needs to be obtained, and the collection, use, and processing of related data comply with related laws, regulations, and standards of related countries and regions.

In summary, in the aspects of this disclosure, the first virtual object is associated with the first account, the second virtual object is associated with the second account, and the state synchronization area is displayed when the first virtual object is in the to-be-synchronized state, so that the interaction between the first account and the second account is triggered, when the first account and the second account are simultaneously in the to-be-synchronized state, by the second virtual object entering the state synchronization area. In this way, entering the state synchronization area can trigger the interaction between the first account and the second account that are simultaneously in the same to-be-synchronized state. In this way, interaction complexity can be reduced, and interaction efficiency can be improved.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely aspects of this disclosure and are not intended to limit the protection scope of this application. Any modification, equivalent replacement, or improvement made without departing from the spirit and range of this disclosure shall fall within the protection scope of this application.

What is claimed is:

1. An interaction method based on a virtual scene, the method comprising:
displaying a first virtual object in a to-be-synchronized state and a state synchronization area in a virtual scene, the first virtual object being controlled by a first user associated with a first account;
displaying a second virtual object outside of the state synchronization area in the virtual scene, the second virtual object being controlled by a second user associated with a second account; and
when the second virtual object enters the state synchronization area, outputting, by processing circuitry, state representation information indicating that the second virtual object is in the to-be-synchronized state.

2. The method according to claim 1, wherein
the to-be-synchronized state of each of the first virtual object and the second virtual object includes at least one of an audio listening state or a video viewing state.

3. The method according to claim 1, wherein the state synchronization area moves synchronously with the first virtual object.

4. The method according to a claim 1, wherein the outputting comprises:
transmitting a state synchronization request to a server device, the state synchronization request including a request to change a state of the second virtual object to the to-be-synchronized state;
receiving current playing content and a current playing progress of the first virtual object transmitted by the server device in response to the state synchronization request; and
playing the current playing content of the state representation information according to the current playing progress.

5. The method according to claim 4, further comprising:
displaying a playback control interface; and
adjusting a playback volume of the current playing content according to a volume adjustment operation being performed on a volume control element in the playback control interface.

6. The method according to claim 1, wherein the outputting comprises:
displaying a permission control element when the second virtual object enters the state synchronization area; and
when a first user operation is performed on the permission control element, outputting the state representation information indicating that the second virtual object is in the to-be-synchronized state.

7. The method of claim 6, wherein the displaying the permission control element comprises:
when the second virtual object enters the state synchronization area, transmitting a permission determining request indicating the second account to a server device, the server device being configured to determine, based on the indicated second account, whether the second virtual object is permitted to be in the to-be-synchronized state;
receiving a permission determining result transmitted by the server device in response to the permission determining request; and
displaying the permission control element when the permission determining result indicates that the second virtual object is not permitted to be in the to-be-synchronized state.

8. The method according to claim 6, further comprising:
when a second user operation is performed on the permission control element, displaying the second virtual object outside of the state synchronization area.

9. The method according to claim 1, further comprising:
based on the second virtual object moving away from the state synchronization area, displaying a separation animation of the second virtual object and the state synchronization area, and ending the output of the state representation information.

10. The method according to claim 1, further comprising:
ending the output of the state representation information in response to receiving a state exit message transmitted by a first electronic device, wherein the state exit message is generated by a first electronic device when the first virtual object exits the to-be-synchronized state.

11. The method according to claim 1, further comprising:
while the second virtual object is in the to-be-synchronized state, receiving content switching information transmitted by a first electronic device, the content switching information being generated by the first electronic device in response to a content switching operation of the to-be-synchronized state of the first virtual object, and the content switching operation being configured to switch state content for the to-be-synchronized state of the first virtual object;
updating the state representation information based on the content switching information, to obtain to-be-output state information; and
outputting the to-be-output state information.

12. The method according to claim 1, wherein the state synchronization area is an area in the virtual scene that is identified by the first user of the first virtual object.

13. The method according to claim 1, wherein the state synchronization area is an area in the virtual scene that changes with a location of the first virtual object.

14. An information processing apparatus, comprising:
processing circuitry configured to:
display a first virtual object in a to-be-synchronized state and a state synchronization area in a virtual scene, the first virtual object being controlled by a first user associated with a first account;
display a second virtual object outside of the state synchronization area in the virtual scene, the second virtual object being controlled by a second user associated with a second account; and
when the second virtual object enters the state synchronization area, output state representation information indicating that the second virtual object is in the to-be-synchronized state.

15. The information processing apparatus according to claim 14, wherein
the to-be-synchronized state of each of the first virtual object and the second virtual object includes at least one of an audio listening state or a video viewing state.

16. The information processing apparatus according to claim 14, wherein the state synchronization area moves synchronously with the first virtual object.

17. The information processing apparatus according to a claim 14, wherein the processing circuitry is configured to:
transmit a state synchronization request to a server device, the state synchronization request including a request to change a state of the second virtual object to the to-be-synchronized state;
receiving current playing content and a current playing progress of the first virtual object transmitted by the server device in response to the state synchronization request; and
playing the current playing content of the state representation information according to the current playing progress.

18. The information processing apparatus according to claim 17, wherein the processing circuitry is configured to:
display playback control interface; and
adjust a playback volume of the current playing content according to a volume adjustment operation being performed on a volume control element in the playback control interface.

19. The information processing apparatus according to claim 14, wherein the processing circuitry is configured to:
display a permission control element when the second virtual object enters the state synchronization area; and
when a first user operation is performed on the permission control element, outputting the state representation information indicating that the second virtual object is in the to-be-synchronized state.

20. A non-transitory computer-readable storage medium, storing instructions which when executed by a processor cause the processor to perform:
displaying a first virtual object in a to-be-synchronized state and a state synchronization area in a virtual scene, the first virtual object being controlled by a first user associated with a first account;
displaying a second virtual object outside of the state synchronization area in the virtual scene, the second virtual object being controlled by a second user associated with a second account; and
when the second virtual object enters the state synchronization area, outputting state representation information indicating that the second virtual object is in the to-be-synchronized state.
